(19) United States
(12) Patent Application Publication
(10) Pub. No.: US 2003/0053467 A1
(43) Pub. Date: Mar. 20, 2003

(54) Packet network transfer apparatus, packet network transfer system and packet network transfer method

(75) Inventor: Rei Miyamoto, Tokyo (JP)

Correspondence Address: YOUNG & THOMPSON, 745 SOUTH 23RD STREET 2ND FLOOR, ARLINGTON, VA, 22202

(73) Assignee: NEC CORPORATION, TOKYO (JP)

(21) Appl. No.: 10/245,354

(22) Filed: Sep. 18, 2002

(30) Foreign Application Priority Data
Sep. 19, 2001 (JP) 2001-284235

(51) Int. Cl. H04L 12/28

(52) U.S. Cl. 370/401; 370/395.1

(57) ABSTRACT

An identifier distinguishing unit 14 distinguishes what the identifier contained in a packet is. A VC search processing unit 13 searches the identifier/VC management table 12 using that identifier as the search character sequence. A VC selecting unit 15 selects an ATM VC for use in transmission on the basis of the ID information on ATM VCs resulting from the search. A cell formation processing unit 16 subjects the packet to ATM self format conversion processing. A frame formation processing unit 24 regenerates individual packets from packet information. A VC distinguishing unit 25 distinguishes the ID information on ATM VCs pertaining to each individual packet. An identifier search processing unit 23 searches the VC/identifier management table 22 using the ID information on ATM VCs as the search character sequence. An identifier assigning unit 26 assigns the identifier resulting from the search to the packet, and supplies that packet. This makes it possible to comprehensively manage packets transferred across a plurality of packet networks having different identifier management policies.

### BACKGROUND OF THE INVENTION

1. Field of the Invention

The present invention relates to a packet network transfer apparatus, a packet network transfer system and a packet network transfer method for transferring packets, and more particularly to a packet network transfer apparatus, a packet network transfer system and a packet network transfer method for giving priority to the transferring of a packet having a specific identifier.

2. Description of the Related Art

In conventional packet network transfer methods, to each packet is assigned an identifier indicating the class of prioritized control unique to that packet, and, the transfer of a packet having a specific identifier is given priority by performing transfer control differentiated by the identifier of each packet.

Such conventional packet transfer methods are prescribed in, for instance, the Institute of Electrical and Electronics Engineers (IEEE) 802.1p Class of Service Protocol, the Internet Protocol (IP) Precedence, the Internet Engineering Task Force (IETF) Differentiated Services and so forth.

According to the IEEE 802.1p Class of Service Protocol here, Class of Service bit information (hereinafter abbreviated to CoS bit) representing an eight-level prioritized control class is inserted to the header of each Ethernet™ packet, and the prioritized control of packets is differentiated according to the value of the CoS bit.

The IP Precedence differentiates the prioritized control of packets according to the value of a Type of Service (TOS) field contained in the header of each IP packet.

According to the IETF Differentiated Services (hereinafter abbreviated to Diffserv), a value known as a Differentiated Services Code Point (DSCP) for exclusive use in Diffserv is inserted into the TOS field contained in the header of each IP packet, and the prioritized control of packets is differentiated on the basis of the prioritized control method or the priority of discarding expressed by the DSCP.

According to the conventional packet network transfer methods described above, in general, to each packet is assigned an identifier indicating the class of prioritized control unique to that packet, and transfer control is carried out according to the identifier of each packet. By implementing such a management policy, it is made possible to give priority to the transfer of a packet having a specific identifier. This management policy also provides specific values representing the position of the identifier in a packet, its length and prioritized control class.

However, if a plurality of packet networks different in management policy are directly connected to each other, an identifier of a high priority class according to the management policy of one packet network may be judged to be an identifier of a low priority class according to the management policy of another packet network which is connected. Also, on account of a difference in the relevance of the position or length of the identifier, a wrong sequence of characters or numerical values may be taken for the identifier of a high priority class. Therefore, no comprehensive prioritized control is possible across a plurality of packet networks.

A problem will also occur if an identifier representing the prioritized control class of the packet is applied for the purpose of representing the logical network attribute information of the packet. A case in which the VLAN ID of a packet defined by the IEEE 802.1Q Virtual Local Area Network (VLAN) Protocol is used as the logical network attribute information of the packet by way of example. The VLAN ID here indicates what VLAN each packet belongs to, and the value of VLAN ID is stored directly into the header of the packet. Therefore, a plurality of packet networks differing in the policy of managing VLAN IDs are directly connected to each other, similarly to the aforementioned problem regarding the prioritized control class, the packet may be mistaken in the packet network which is the destination of the transfer for a packet belonging to an entirely different VLAN.

### SUMMARY OF THE INVENTION

An object of the present invention is to provide a packet network transfer apparatus, a packet network transfer system and a packet network transfer method permitting comprehensive management of packets transferred across a plurality of packet networks having different management policies.

A packet network transfer system according to the invention links by a logical connection a first packet network having a first management policy setting forth intra-network transfer management rules and a second packet network having a second management policy,

provided on the part of the first packet network with a first management table for storing the association between a first identifier used under the first management policy and the logical connection; and

a logical connection selecting unit for selecting, when a packet is to be transferred over the logical connection from the first packet network to the second packet network, the logical connection for the transmission of the packet according to the contents of the first identifier and on the basis of the stored contents of the first management table; and

provided on the part of the second packet network with a second management table for storing the association between a second identifier used under the second management policy and the logical connection; and

an identifier assigning unit for newly assigning the second identifier to a packet to be delivered to the second packet network according to the logical connection at which the packet has arrived and on the basis of the stored contents of the second management table, wherein:

the contents signified by the second identifiers are set to be similar to the contents signified by the first identifier associated with the logical connection.

Since in this configuration, even where an identifier manifesting a high priority class under the management policy of one packet network is used as a low priority class identifier under the different management policy of another packet network to which it is connected, the arriving side processing unit on the arriving side network alters the low priority class identifier into a high priority class identifier, which is newly assigned to a desired position in the header or the payload of the packet, it is made possible to realize comprehensive management of packets transferred across a plurality of packet networks.

### BRIEF DESCRIPTION OF THE DRAWINGS

The above and other objects, features and advantages of the present invention will become more apparent from the following detailed description when taken in conjunction with the accompanying drawings wherein:

FIG. 1 is a block diagram illustrating the configuration of a packet network transfer system, which is a preferred embodiment of the invention;

FIG. 2 is a block diagram illustrating a specific example of system configuration of a packet network transfer system, which is a preferred embodiment of the invention;

FIG. 3 illustrates a detailed configuration of the identifier/VC management table in FIG. 1;

FIG. 4 illustrates a detailed configuration of the VC/identifier management table in FIG. 1;

FIG. 5 is a flow chart showing the operation of the packet network transfer system in the preferred embodiment of the invention;

FIG. 6 is a flow chart showing the search processing operation by the VC search processing unit in FIG. 1;

FIG. 7 is a flow chart showing the search processing operation by the identifier search processing unit in FIG. 1; and

FIG. 8 illustrates an example of packet configuration prescribed under the VLAN Protocol.

### DETAILED DESCRIPTION OF THE PREFERRED EMBODIMENT

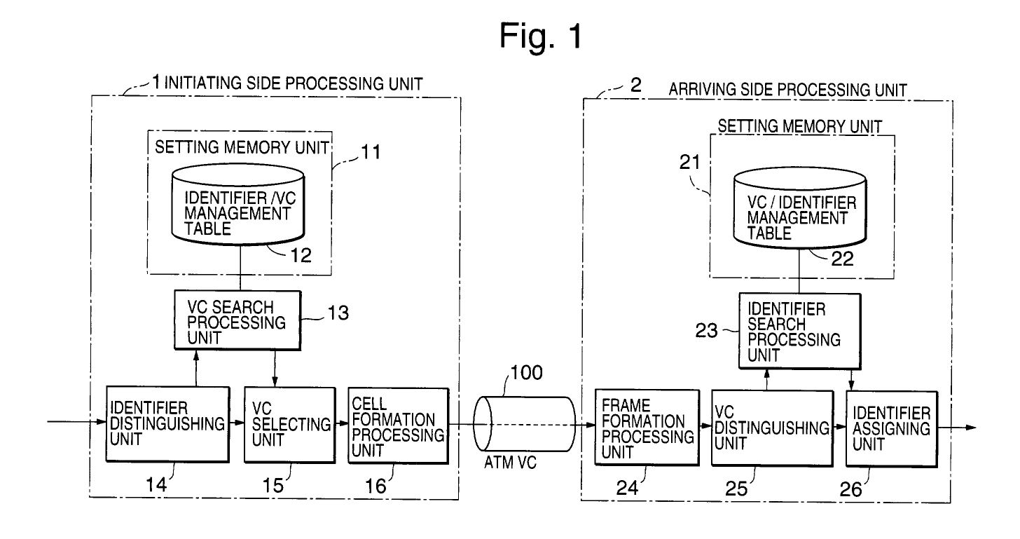

A packet network transfer apparatus, a packet network transfer system and a packet network transfer method embodying the present invention will be described with reference to FIG. 1 through FIG. 8.

FIG. 1 is a block diagram illustrating the configuration of a packet network transfer system, which is a preferred embodiment of the invention. Referring to FIG. 1, the packet network transfer system, which is a preferred embodiment of the invention, comprises an initiating side processing unit 1, an arriving side processing unit 2 and an asynchronous transfer mode (ATM) network 100, and they process transferring of packets under priority control according to their attributes.

The initiating side processing unit 1 processes transmission of a packet from the initiating side network (not shown) to an ATM virtual connection (VC) of the ATM network 100. The arriving side processing unit 2 processes reception of a packet from the ATM VC in the arriving side network (not shown) These initiating side processing unit 1 and arriving side processing unit 2 perform one-way communication of the packet.

The initiating side processing unit 1 comprises a setting memory unit 11 having an identifier/VC management table 12, a VC search processing unit 13, an identifier distinguishing unit 14, a VC selecting unit 15 and a cell formation processing unit 16.

The identifier distinguishing unit 14 extracts a sequence of characters of a desired length from a desired position in the header or the payload of an entered packet, and judges what the identifier contained in the packet is. The identifier may be, for instance an IEEE 802.1p Class of Service field defined under the IEEE 802. ID Protocol, a Type field defined under the Ethernet™ Protocol, a logical link control (LLC)/sub network access protocol (SNAP) field defined under the IEEE 802.3 Protocol, a differentiated service code point (DSCP) defined under the IETF Differentiated Service (Diffserv), a type of service (TOS) field in the header of the IP packet, a port number contained in the transmission control protocol (TCP)/user datagram protocol (UDP) header of the IP packet or the like.

In the identifier/VC management table 12 of the setting memory unit 11 is structured a search table using as a search character sequence an identifier entered from the identifier distinguishing unit 14, and supplying as the result of search the identification (ID) information of the ATM VC needed for specifying the ATM VC. The processing to search this identifier/VC management table 12 is accomplished by the VC search processing unit 13. In this embodiment of the invention, the ID information on ATM VCs supplied by the VC search processing unit 13 as the result of search is to specify the ATM VC of the ATM network 100. This ID information on ATM VCs is also the information for specifying the ATM VC when a packet containing the identifier which is the aforementioned search character sequence is transmitted from the VC selecting unit 15.

The VC selecting unit 15 selects the ATM VC for transmission on the basis of the ID information on ATM VCs supplied from the VC search processing unit 13, and performs packet transmission. The cell formation processing unit 16 carries out ATM self format conversion processing needed for transmitting a packet processed by the initiating side processing unit 1 on the ATM VC of the ATM network 100. Examples of ATM self format conversion processing include the IETF request for comments (RFC) 1483 Recommendation.

The ATM VC of the ATM network 100 is an ATM logical connection for connecting the initiating side processing unit 1 and the arriving side processing unit. This ATM logical connection is realized with an ATM network consisting of an ATM switchboard and ATM lines. Although only one ATM logical connection is shown with respect to this embodiment for the sake of simplicity of description, one or a plurality of ATM logical connections are present between the initiating side processing unit 1 and the arriving side processing unit 2 in a usual form of operation.

The arriving side processing unit 2 comprises a setting memory unit 21 having a VC/identifier management table 22, an identifier search processing unit 23, a frame formation processing unit 24, a VC distinguishing unit 25 and an identifier assigning unit 26.

The frame formation processing unit 24 receives an ATM cell from an ATM logical connection including an ATM VC terminated by the arriving side processing unit 2, and regenerates individual packets from packet information contained in the received ATM cell. The VC distinguishing unit 25 distinguishes the ID information on ATM VCs of each packet the ATM VC from which the individual packets have been received.

In the VC/identifier management table 22 of the setting memory unit 21 is structured a search table using as a search character sequence ID information entered from the VC distinguishing unit 25, and supplying as the result of search an identifier to be newly assigned to the packet. The processing to search this VC/identifier management table 22 is accomplished by the identifier search processing unit 23. The identifier assigning unit 26 newly assigns the identifier supplied from the identifier search processing unit 23 as the result of search into any desired position in the header or the payload of the packet, and supplies it.

Methods of associating the contents of the identifier/VC management table 12 of the above-described initiating side processing unit 1 and those of the VC/identifier management table 22 of the arriving side processing unit 2 include, for instance, one by which a network manager comprehensively managing both the initiating side processing unit 1 and the arriving side processing unit 2 sets the contents of the identifier/VC management table 12 and of the VC/identifier management table 22.

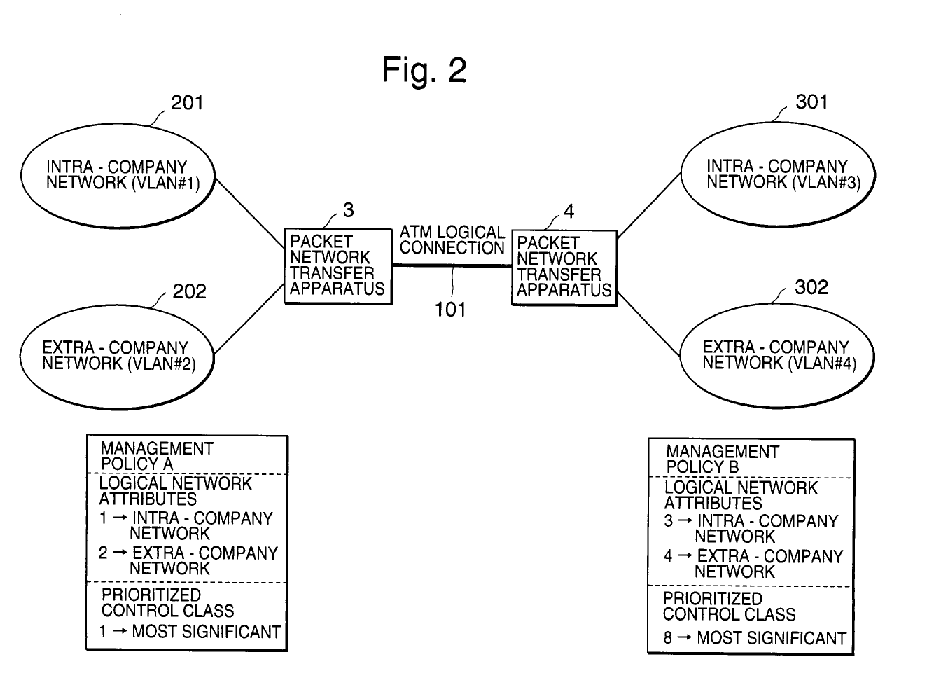

FIG. 2 is a block diagram illustrating a specific example of system configuration of a packet network transfer system, which is a preferred embodiment of the invention. Referring to FIG. 2, the packet network transfer system embodying the invention comprises a packet network transfer apparatus 3 to which an intra-company network (VLAN#1) 201 and an extra-company network (VLAN#2) 202 are connected and a packet network transfer apparatus 4 to which an intra-company network (VLAN#3) 301 and an extra-company network (VLAN#4) 302 are connected, the two transfer apparatuses being connected to each other by an ATM logical connection 101.

Each of the packet network transfer apparatuses 3 and 4 has, built into it, the initiating side processing unit 1 and the arriving side processing unit 2 described above. With the functions of these two kinds of processing units, the packet network transfer apparatuses 3 and 4 realize two-way communication by which packets are transferred to and from each other via the ATM logical connection 101.

It is supposed that, by way of example, the intra-company network 201 and the extra-company network 202 constitute a packet network on the initiating side. They have a management policy A including logical network attribute information of “1→intra-company network and 2→extra-company network” and prioritized control class information of “1→most significant”.

It is further supposed that, by way of example, the intra-company network 301 and the extra-company network 302 constitute a packet network on the arriving side. They have a management policy B including logical network attribute information of “3→intra-company network and 4→extra-company network” and prioritized control class information of “8→most significant”. The following description will take up only the prioritized control class information, and the contents of the description are supposed to be applicable to the logical network attribute information as well.

The management policies A and B set forth, in digitizing the prioritized control class and VLAN attribute (information as to which VLAN it belongs) of the packet and inserting them into their respectively prescribed positions (header and payload) in the packet in the networks, how the resultant numerical values and what they respectively signify are associated with each other. In other words, the management policy A sets forth transfer management rules in the packet network on the initiating side, and the management policy B, transfer management rules in the packet network on the arriving side.

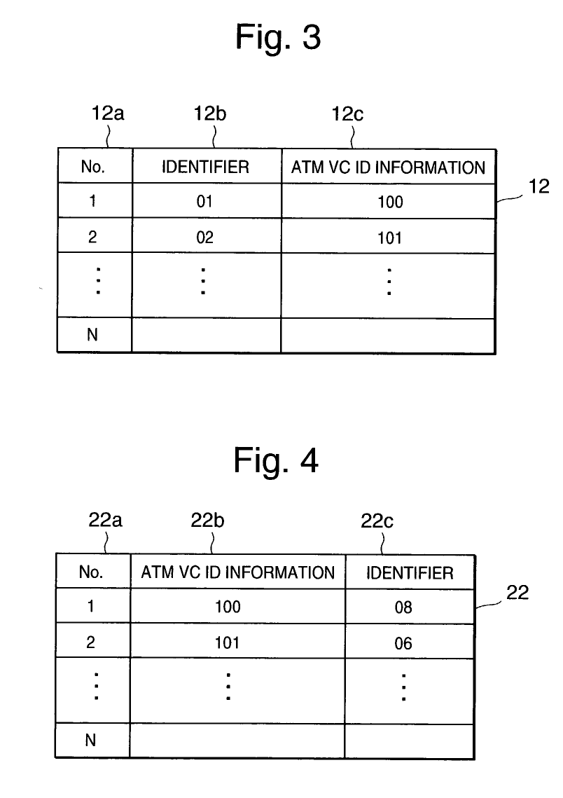

FIG. 3 illustrates a detailed configuration of the identifier/VC management table 12 in FIG. 1.

Referring to FIG. 3, numeral 12a denotes the row number in the identifier/VC management table 12. This numeral 12a is a unique value, that can be any one of consecutive integers from “1” to “N” in a table having N rows.

In the identifier 12b column, character sequences “01”, “02”, . . . in the packet header or the packet payload extracted by the identifier distinguishing unit 14 are entered. By setting this identifier as desired, any prioritized control class can be identified. The identifier “01” here signifies the most significant prioritized control class, and the identifier “02”, a medium prioritized control class.

In the ATM VC ID information 12c column are stored in every case ID information pieces respectively signifying specific ATM logical connections. In this embodiment, there are stored ID information pieces “100”, “101”, . . . which specify ATM VCs of the ATM network 100.

FIG. 4 illustrates a detailed configuration of the VC/identifier management table 22 in FIG. 1.

Referring to FIG. 4, numeral 22a denotes the row number in the identifier/VC management table 22. This numeral 22a is a unique value, that can be any one of consecutive integers from “1” to “N” in a table having N rows.

In the ATM VC ID information 22b are stored the ID information pieces of all the ATM VCs terminated by the arriving side processing unit 2. In this embodiment, there are stored ID information pieces “100”, “101”, . . . which specify ATM VCs of the ATM network 100.

In the identifier 22c column are stored in every case identifier information pieces “08”, “06”, . . . which are to be assigned to packets by the identifier assigning unit 26. The identifier “08” here signifies the most significant prioritized control class, and the identifier “06”, a medium prioritized control class.

Thus, as the identifier/VC management table 12 stores the ID information “100” to specify an ATM VC matching the identifier “01” signifying the most significant prioritized control class, the VC/identifier management table 22 stores the identifier “08” signifying the most significant prioritized control class matching the ID information “100” specifying an ATM VC.

Similarly, as the identifier/VC management table 12 stores ID information “101” to specify an ATM VC matching the identifier “02” signifying a medium prioritized control class, the VC/identifier management table 22 stores the identifier “06” signifying the medium prioritized control class matching the ID information “101” specifying an ATM VC.

Incidentally, since the means for realizing the aforementioned ATM VC and ATM logical connection, that for conversion into an ATM cell format, and that for regenerating individual packets from the packet information contained in the ATM cell format are well known to persons skilled in the art, and have no direct relevance to the present invention, detailed description of their configurations and operations is dispensed with.

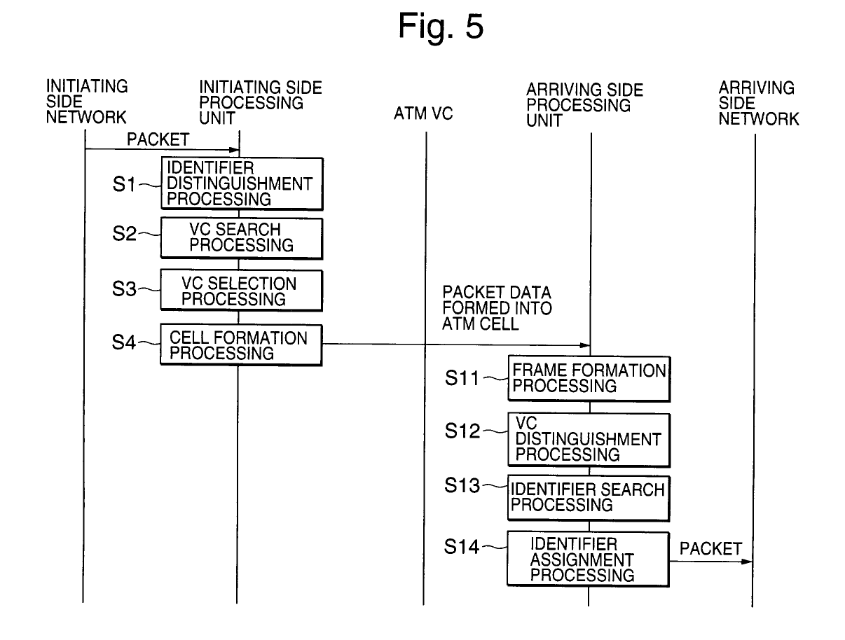

FIG. 5 is a flow chart showing the operation of the packet network transfer system in the preferred embodiment of the present invention. The packet network transfer system embodying the invention in this mode will be described below with reference to FIG. 1 and FIG. 5.

A packet entered from the initiating side network into the initiating side processing unit 1 first undergoes distinguishment of the identifier indicating the prioritized control class unique to that packet by the identifier distinguishing unit 14 (step S1 in FIG. 5). More specifically, first the identifier distinguishing unit 14 extracts from any desired position in the header or the payload of the entered packet an identifier, which may be a character sequence of any length. Next, the identifier distinguishing unit 14 distinguishes according to the extracted identifier what the identifier contained in the packet is. The identifier extracted by the identifier distinguishing unit 14 is handed over to the VC search processing unit 13, and the packet itself is taken over by the VC selecting unit 15. The VC search processing unit 13, using as a search character sequence the identifier received from the identifier distinguishing unit 14, searches the identifier/VC management table 12. Then it supplies the ID information on ATM VCs to the VC selecting unit 15 as the search result (step S2 in FIG. 5). Details of this search processing by the VC search processing unit 13 will be described in detail afterwards.

The VC selecting unit 15 selects, on the basis of the ID information on ATM VCs supplied from the VC search processing unit 13, the ATM VC to which the packet taken over from the identifier distinguishing unit 14 is to be transmitted, and performs transmission processing (step S3 in FIG. 5). In this embodiment of the invention, the aforementioned ID information on ATM VCs is supposed to specify the ATM VC of the ATM network 100, and the VC selecting unit 15 performs processing to transmit the taken-over packet to the ATM VC of the ATM network 100.

The packet transmitted from the VC selecting unit 15 undergoes processing by the cell formation processing unit 16 for conversion into an ATM cell format required for transmission to the ATM VC of the ATM network 100. The packet converted into an ATM cell is transferred over the ATM VC of the ATM network 100 (step S4 in FIG. 5).

Data in the packet transferred by the ATM cell via the ATM VC of the ATM network 100 are regenerated by the frame formation processing unit 24 of the arriving side processing unit 2, using packet information contained in the ATM cell format, into the packet before the conversion into the ATM cell format by the cell formation processing unit 16. The regenerated packet is taken over by the VC distinguishing unit 25 (step S11 in FIG. 5).

The VC distinguishing unit 25 distinguishes, according to the ATM VC via which the taken-over packet has come, the ID information on ATM VCs pertaining to that packet (step S12 in FIG. 5). The ID information on ATM VCs is supplied to the identifier search processing unit 23. The packet itself is taken over by the identifier assigning unit 26 from the VC distinguishing unit 25.

The identifier search processing unit 23 searches the VC/identifier management table 22 using as a search character sequence the ID information on ATM VCs received from the VC distinguishing unit 25. The identifier search processing unit 23 supplies the identifier assigning unit 26 with the identifier to be newly assigned as the result of search (step S13 in FIG. 5). Details of this search processing by the identifier search processing unit 23 will be described in detail afterwards.

The identifier assigning unit 26 assigns an identifier supplied from the identifier search processing unit 23 to the packet taken over from the VC distinguishing unit 25. The packet to which the identifier has been assigned is supplied from the identifier assigning unit 26, i.e. the arriving side processing unit 2 (step S14 in FIG. 5).

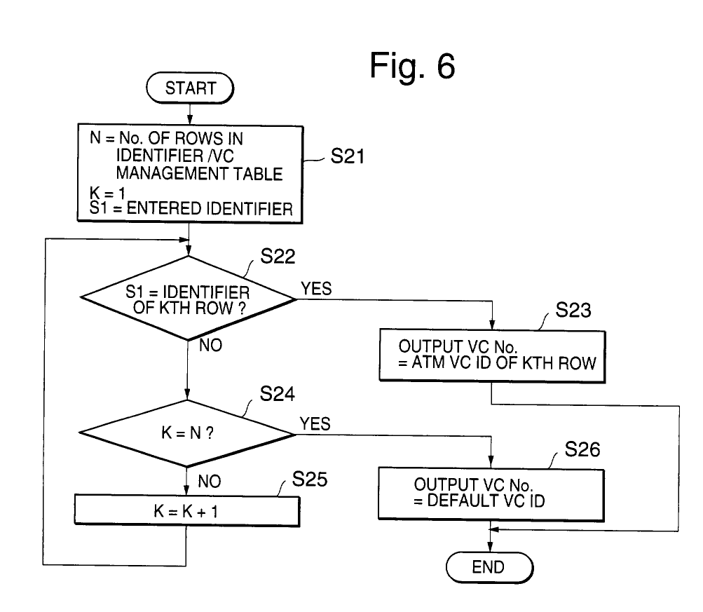

FIG. 6 is a flow chart showing the VC search processing operation by the VC search processing unit 13 in FIG. 1. Now the search processing operation by the VC search processing unit 13 will be described in detail with reference to these FIG. 1, FIG. 3 and FIG. 6.

First, variables used in this search processing are initialized. An integer N is initialized to the number of rows in the identifier/VC management table 12 shown in FIG. 1, i.e. the maximum number of entries the table can accommodate. An integer K is initialized to “1”. A character sequence S1 is initialized to the identifier entered from the identifier distinguishing unit 14 into the VC search processing unit 13 shown in FIG. 1 (step S21 in FIG. 6).

In the first distinguishment processing as referred to in FIG. 6, it is judged whether or not the identifier, which is the character sequence S1, and the entry on the Kth row of data structure of the identifier/VC management table 12 shown in FIG. 3, i.e. the identifier 12b contained in the entry where in the numeral 12a is “K”, are identical with each other (step S22 in FIG. 6).

If they are, the ID information on ATM VCs, which is the output of this search processing, is deemed to be the value of the ATM VC ID information 12c contained in the above-mentioned Kth entry (step S23 in FIG. 6), and this search processing is completed.

On the other hand, if they are not found identical in the first distinguishment processing, the process proceeds to second distinguishment processing. In the second distinguishment processing, it is checked whether or not K and N are identical with each other (step S24 in FIG. 6). A case in which K and N are found identical here means a case in which, with no identity found in the first distinguishment processing, search processing arrives at the final entry in the identifier/VC management table 12 shown in FIG. 3. In other words, it is a case in which the identifier consisting of the character sequence S1 turns out not being entered in the identifier/VC management table 12. Therefore, a preset ATM VC ID (default VC ID) value is assigned to the ID information on ATM VCs, which is the output of this search processing (step S26 in FIG. 6), and this search processing is completed.

Further, if K and N are not found identical in the second distinguishment processing, the value of K is counted up by one (step S25 in FIG. 6), and the process returns to step S22 to execute the aforementioned first distinguishment processing again.

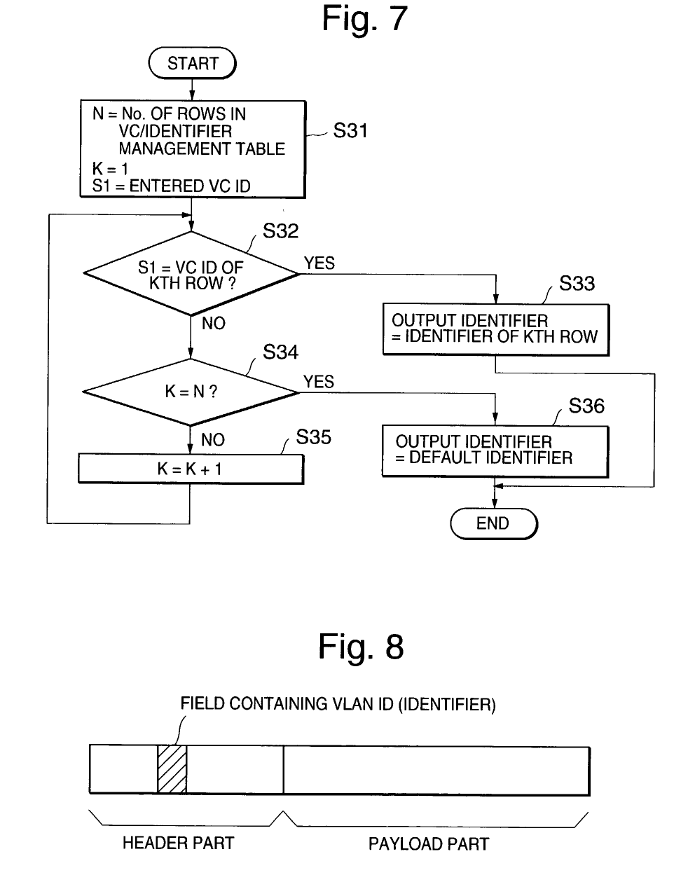

FIG. 7 is a flow chart showing the search processing operation by the identifier search processing unit 23 in FIG. 1. Details of the search processing operation by the identifier search processing unit 23 will be described below with reference to these FIG. 1, FIG. 4 and FIG. 7.

First, variables used in this search processing are initialized. An integer N is initialized to the number of rows in the identifier/VC management table 22 shown in FIG. 1, i.e. the maximum number of entries the table can accommodate. An integer K is initialized to “1”. A character sequence S1 is initialized to the ID information on ATM VCs entered from the VC distinguishing unit 25 into the VC search processing unit 23 shown in (step S31 in FIG. 7).

In first distinguishment processing shown in FIG. 7, it is judged whether or not the ID information on ATM VCs, which is the character sequence S1, the entry on the Kth row in the data structure of the VC/identifier management table 22 shown in FIG. 4, i.e. ATM VC ID information 22b contained in the entry whose numeral 22a is “K”, are identical with each other (step S32 in FIG. 7).

If they are, the identifier, which is the output of this search processing, is deemed to be the value of the identifier 22c contained in the above-mentioned Kth entry (step S33 in FIG. 7), and this search processing is completed.

On the other hand, if they are not found identical in the first distinguishment processing, the process proceeds to second distinguishment processing. In the second distinguishment processing, it is checked whether or not K and N are identical with each other (step S34 in FIG. 7). A case in which K and N are found identical here means a case in which, with no identity found in the first distinguishment processing, search processing arrives at the final entry in the VC/identifier management table 22 shown in FIG. 4. In other words, it is a case in which the ID information on ATM VCs consisting of the character sequence S1 turns out to be not entered in the VC/identifier management table 22. Therefore, a preset identifier (default identifier) value is assigned to the identifier, which is the output of this search processing (step S36 in FIG. 7),and this search processing is completed.

Further, is K and N are not found identical in the second distinguishment processing, the value of K is counted up by one (step S35 in FIG. 7), and the process returns to step S32 to execute the aforementioned first distinguishment processing again.

Thus in this embodiment of the invention, when a packet is to be transferred from a packet network having one identifier management policy A (hereinafter referred to as the initiating side network) to another packet network having a different identifier management policy B (hereinafter referred to as the arriving side network) via an ATM VC, identifiers and ATM VCs are associated with each other so that prioritized control classes indicated by the respective identifiers in the initiating side network and the arriving side network be the same in relative terms, and the ATM VC by which the packet is to be transmitted is selected according to the identifier used in the initiating side network. Further, by assigning the identifier in the arriving side network according to the ATM VC having arrived in the arriving side network, it is made possible to realize comprehensive priority control across a plurality of packet networks having the different identifier management policies A and B. Thus, in this embodiment of the invention, it is made possible to comprehensively manage packets transferred across a plurality of packet networks having the different identifier management policies A and B.

Similar processing would make it possible, where a plurality of packet networks using manners of priority control, such as the IEEE 802.1p Protocol, the IETF Differentiated Services, IP Precedence and the like, are directly connected, to prevent wrong character sequences and numerical values in a packet from being mistaken for a high priority control class, and transfer packet attributes of the intended priority control class.

It is further made possible to distinguish the prioritized control class according to the identifier of the packet, select an ATM VC permitting appropriate quality assurance, and transfer the packet accordingly.

Next will be described the processing that takes place when the identifier information is altered from what indicates the prioritized control class of the packet to what indicates the logical network attribute information of the packet. Examples of the logical network attribute information of the packet here include the VLAN ID for packets prescribed under the virtual local area network (VLAN) Protocol of IEEE 802.1Q.

FIG. 8 illustrates an example of packet configuration prescribed under the VLAN Protocol. Referring to FIG. 8, the packet consists of a header part and a payload part, and the header part stores VLAN IDs which are information indicating which packet belongs to which VLAN.

Here is considered a case, by way of example, in which a plurality of packet networks having different VLAN ID management policies A and B are directly connected to each other as shown in FIG. 2. It is supposed that a packet bearing “1”, which is a VLAN ID value used in the intra-company network 201 is sent from the intra-company network 201 to at least either the intra-company network 301 or the extra-company network 302 via the packet network transfer apparatuses 3 and 4.

Where a packet is to be transferred from the intra-company network 201 having the management policy A to at least either the intra-company network 301 or the extra-company network 302 having the management policy B different from A via the ATM logical connection 101, VLAN IDs and ATM VCs are associated so that the VLAN attributes indicating the respective VLAN IDs in the initiating side network and the arriving side network be the same in relative terms, and the ATM VC for transmitting the packet is selected according to the VLAN ID to be used in the initiating side network. Further, a VLAN ID in the arriving side network is newly assigned according to the ATM VC having reached the arriving side network.

In this case, the VLAN ID “1” assigned to the packet from the intra-company network 201 is transmitted from the packet network transfer apparatus 3 via the ATM logical connection 101. Then, by replacing “1” of the VLAN ID of the packet received by the packet network transfer apparatus 4 via the ATM logical connection 101 with “3” and transferring the packet so processed to at least either the intra-company network 301 or the extra-company network 302, at least either the intra-company network 301 or the extra-company network 302, whichever may apply, can recognize it as a packet coming from the intra-company network.

In this way a virtual LAN across the plurality of networks having different VLAN ID management policies A and B can be realized. Thus, this embodiment of the invention can achieve comprehensive management of packets transferred across a plurality of packet networks having different identifier management policies.

Further in this invention, the ATM logical connections using ATM VCs can be replaced with label switched path (LSP) logical connections used in the IETF multi-protocol label switching (MPLS) technique.

This replacement of logical connections would also make it possible to solve similar problems to those noted above where a plurality of packet networks are connected using LSP logical connections. Detailed description of the MPLS technique is dispensed with here because it is described in, for instance, the Request for comments (RFC) 3031, “Multiprotocol Label Switching Architecture”.

The present invention can provide the following benefits. It is made possible to comprehensively manage packets transferred across a plurality of packet networks having different identifier management policies. The identifier information here may be either what indicates the prioritized control class of the packet or what indicates the logical network attribute information of the packet.

The connections connecting the plurality of packet networks may be either ATM logical connections or LSP logical connections.

While this invention has been described with reference to a certain preferred embodiment, it is to be understood that the subject matter encompassed by the invention is not limited to this specific embodiment. Instead it is intended for the subject matter of the invention to include all such alternatives, modifications and equivalents as can be included within the spirit and scope of the following claims.

What is claimed is:

1. A packet network transfer apparatus for linking by a logical connection a first packet network having a first management policy setting forth intra-network transfer management rules and a second packet network having a second management policy, wherein:
the initiating side processing unit of said packet network transfer apparatus, comprising:
a first management table for storing the association between a first identifier used under said first management policy and said logical connection; and
a logical connection selecting unit for selecting, when a packet is to be transferred via said logical connection from said first packet network to said second packet network, said logical connection for the transmission of said packet according to the contents of said first identifier and on the basis of the stored contents of said first management table.

2. A packet network transfer apparatus for linking by a logical connection a first packet network having a first management policy setting forth intra-network transfer management rules and a second packet network having a second management policy, wherein:
the arriving side processing unit of said packet network transfer apparatus, comprising:
a second management table for storing the association between a second identifier used under said second management policy and said logical connection; and
an identifier assigning unit for newly assigning said second identifier to a packet to be delivered to said second packet network according to the logical connection at which said packet has arrived and on the basis of the stored contents of said second management table.

3. A packet network transfer system for linking by a logical connection a first packet network having a first management policy setting forth intra-network transfer management rules and a second packet network having a second management policy,
on the part of said first packet network, comprising:
a first management table for storing the association between a first identifier used under said first management policy and said logical connection; and
a logical connection selecting unit for selecting, when a packet is to be transferred via said logical connection from said first packet network to said second packet network, said logical connection for the transmission of said packet according to the contents of said first identifier and on the basis of the stored contents of said first management table; and
on the part of said second packet network, comprising:
a second management table for storing the association between a second identifier used under said second management policy and said logical connection; and
an identifier assigning unit for newly assigning said second identifier to a packet to be delivered to said second packet network according to the logical connection at which said packet has arrived and on the basis of the stored contents of said second management table, wherein:
said first and second identifiers are associated with a common logical connection.

4. The packet network transfer system, as claimed in claim 3, wherein:
said logical connection is an asynchronous transfer mode (ATM) logical connection.

5. The packet network transfer system, as claimed in claim 3, wherein:
said logical connection is a label switched path (LSP) logical connection.

6. The packet network transfer system, as claimed in claim 3, wherein:
said identifier is an item of information representing the prioritized control class of said packet.

7. The packet network transfer system, as claimed in claim 4, wherein:
said identifier is an item of information representing the prioritized control class of said packet.

8. The packet network transfer system, as claimed in claim 5, wherein:
said identifier is an item of information representing the prioritized control class of said packet.

9. The packet network transfer system, as claimed in claim 5, wherein:
said identifier is an item of information representing the logical network attribute information on said packet.

10. The packet network transfer system, as claimed in claim 4, wherein:
said identifier is an item of information representing the logical network attribute information on said packet.

11. The packet network transfer system, as claimed in claim 5, wherein:
said identifier is an item of information representing the logical network attribute information on said packet.

12. A packet network transfer system for linking by a logical connection a first packet network having a first management policy setting forth intra-network transfer management rules to a second packet network having a second management policy, comprising:
a step of selecting, on the basis of the association between a first identifier used under said first management policy and said logical connection and in advance of transferring a packet from said first packet network to said second packet network over said logical connection, said logical connection for the transmission of said packet according to the contents of said first identifier and
a step of newly assigning, on the basis of the association between a second identifier used under said second management policy and said logical connection, said second identifier to a packet having arrived at said second packet network according to the logical connection, wherein:
said first and second identifiers are associated with a common logical connection.
